(19) United States
(12) Patent Application Publication
(10) Pub. No.: US 2022/0296455 A1
(43) Pub. Date: Sep. 22, 2022

(54) CLOTHING ITEM

(71) Applicant: Katerina SEDLACKOVA, Graz (AT)

(72) Inventor: Katerina SEDLACKOVA, Graz (AT)

(21) Appl. No.: 17/719,544

(22) Filed: Apr. 13, 2022

Related U.S. Application Data
(63) Continuation of application No. PCT/AT2020/060334, filed on Sep. 16, 2020.

(30) Foreign Application Priority Data
Oct. 15, 2019 (AT) A 50883/2019

(51) Int. Cl. A61H 3/06; G01C 21/36

(52) U.S. Cl. CPC A61H 3/061; G01C 21/3652; A61H 2003/063; A61H 2201/165; A61H 2201/5007; A61H 2201/5092; A61H 2205/083; A61H 2201/5084

(57) ABSTRACT

A clothing item, in particular a belt, with at least two actuators for triggering tactile stimuli for a person wearing the clothing item, wherein the at least two actuators are or can be connected to a control unit for actuating the actuators, the control unit is formed to activate the at least two actuators within the scope of at least two activation patterns, and the at least two activation patterns are assigned to different action instructions for the person wearing the clothing item, which action instructions can be output to the person wearing the clothing item via the activation of the activation patterns, wherein the at least two activation patterns include the combined activation of the at least two actuators at different parts of the body that are distinguishable for the person wearing the clothing item.

The invention relates to a clothing item, in particular a belt, with at least two actuators for triggering tactile stimuli for a person wearing the clothing item, wherein
the at least two actuators are or can be connected to a control unit for actuating the actuators,
the control unit is formed to activate the at least two actuators within the scope of at least two activation patterns, and
the at least two activation patterns are assigned to different action instructions for the person wearing the clothing item,

which action instructions can be output to the person wearing the clothing item via the activation of the activation patterns.

Furthermore, the invention relates to a method for operating at least two actuators on a clothing item.

A navigation device for the blind which works with acoustic instructions is already known from the state of the art. Acoustic signals and directions are conveyed to the user via headphones. However, it is not possible to exercise (e.g. run or cycle) with this disclosure. Moreover, it is not designed to transmit real-time information regarding the environment. Thus, if obstacles or the like arise, the directions cannot be adapted quickly enough.

Furthermore, a device is known with the aid of which acoustic signals are transmitted to the user and information regarding the environment is provided to the user in real time. However, this device for the visually impaired is not suitable for exercise either, since the device cannot be used without an additional aid (for example a white cane).

A clothing item in the form of a shoe is also known. This shoe is formed to help the blind get around. It transmits information regarding the environment to the user in real time. Haptic or tactile signals or impulses for the user are transmitted via the clothing item. This device for the visually impaired is not suitable for exercise either, since it only helps with getting around and the device cannot be used without an additional aid (e.g. a white cane) because the transmission of tactile signals to the foot surface is very limited.

A clothing item with the help of which the visually impaired can exercise is likewise known from the state of the art. This is made possible by giving haptic impulses in the desired direction of movement via a belt which is arranged on the abdomen. However, it does not obtain any real-time data regarding the environment and obstacles and thus cannot react quickly enough to any obstacles or the like that arise.

It is also already known that various smartwatches, e.g. the Apple Watch, can convey simple directions, such as left, right or stop, by way of certain signal sequences (e.g. by vibrating).

A necklace is known from GB 2522866 A, which, via the activation of actuators in rudimentary activation patterns, can convey not only directions such as north, east, north-east, south-east etc., but also in-between directions.

The object of the present invention is therefore to provide a clothing item, in particular a belt, which avoids the above disadvantages or which provides an improved navigation for the visually impaired when exercising.

This object is achieved by a clothing item with the features of claim 1, a method for operating at least two actuators on a clothing item according to claim 16, and a computer program product for operating at least two actuators on a clothing item according to claim 18.

In the clothing item according to the invention, this is achieved in that the at least two activation patterns include the combined activation of the at least two actuators at different parts of the body that are distinguishable for the person wearing the clothing item.

Computer technology devices which are worn on the body or head are referred to as wearables; the clothing item according to the invention can therefore also be described as a wearable.

The at least two activation patterns, which consist of a combination of actuators activated simultaneously, temporally overlapping and/or successively, allow more complex instructions to be realized than in the present state of the art. A complex instruction, such as turn in a circle, can be given by a specific pattern, for example. The instructions can also be “strengthened” or “weakened” (quickly stop left or stop slowly) through the activation time or activation intensity. Through these additional possibilities for instructions, considerably more action instructions can be presented, as a result of which the improved navigation can be achieved, for example.

According to a further aspect of the invention, a method for operating two actuators on a clothing item is described, wherein
within the scope of at least two activation patterns, which are assigned to action instructions for the person wearing the clothing item, the at least two actuators are activated in a combined manner at different parts of the body that are distinguishable for the person wearing the clothing item, and
the action instructions are output to the person wearing the item of clothing via the activation of the activation patterns.

According to a further aspect of the invention, a computer program product for operating at least two actuators on a clothing item is described, wherein the program commands cause an executing computer to output actuator signals to the at least two actuators within the scope of at least two activation patterns in response to an input signal, with the result that the at least two actuators are activated in a combined manner at different parts of the body that are distinguishable for the person wearing the clothing item.

The tactile stimuli can be triggered in particular by vibration (vibrotactile stimuli).

Further advantageous embodiments of the invention are defined in the dependent claims.

Instead of one single item of clothing, several clothing items can of course also be used on several parts of the body.

A closure for fixing the item of clothing in the desired position can be provided on the item of clothing. This closure can be formed as a hook-and-loop fastener; but of course other types of closure are also conceivable.

The clothing item can be made substantially out of neoprene, but of course other materials, preferably breathable and functional materials, are also conceivable.

The actuators can be formed as vibration motors, for example in the form of unbalance motors.

Other forms of actuators which transmit signals e.g. through electrical impulses, pressure or temperature differences are likewise possible.

In a preferred embodiment, the control unit is formed to activate the at least two actuators within the scope of the activation patterns in a predetermined chronological sequence. In particular simultaneously or in a defined chronological series.

Alternatively or additionally, the temporally overlapping activation of different actuators is possible.

It is thereby possible to generate a plurality of different activation patterns.

Thus, different activation patterns can be presented for different motion sequences.

The control unit need not be arranged on the item of clothing itself; it is also conceivable that the control unit is arranged externally (e.g. an app on a smartphone) and is connected to the clothing item via a means of communication.

The control unit can be the executing computer within the meaning of the invention.

In a further preferred embodiment, it is provided that the at least two activation patterns include the combined activation of a partial quantity of the at least two actuators at different parts of the body that are distinguishable for the person wearing the clothing item.

In a further preferred embodiment of the invention, there are more than two actuators. It has proved to be particularly advantageous if the plurality of actuators can be activated in groups, wherein a group preferably consists of at least three actuators.

This results in the advantage that several activation patterns that are easily distinguishable for the person wearing the clothing item can be implemented. In an embodiment of the invention, the actuators that are assigned to a group are arranged on a common support element.

In a further preferred embodiment of the invention, the at least two actuators are assigned to specific parts of the body. It has proved to be particularly advantageous if the in each case two actuators are assigned to muscle groups. The muscle groups that have proved to be particularly advantageous are musculus rectus abdominis, musculus obliquus externus abdominis, musculus erector spinae, abdomen, upper abdomen, lower abdomen, back, lower back, upper back, waist, left side of waist and right side of waist, because the activated actuators at these body parts are particularly easily distinguishable for the person.

In a further preferred embodiment of the invention, the arrangement of the at least two actuators at different locations is possible via corresponding arrangement of the support element of the respective group. (Actuators arranged together on one support element can also be referred to as “tactors”).

This results in the advantage that the at least two actuators can be arranged such that they are adapted to the shape of the body precisely at the desired parts of the body. In other words, the at least two actuators can be moved to the desired parts of the body—e.g. by detaching and re-attaching them.

In a further preferred embodiment of the invention, the control unit is connected to at least one environment sensor for detecting the position of the person and/or for detecting positions of objects in the environment of the person. The control unit is formed to output the action instructions to the person wearing the item of clothing via the activation of the activation patterns in response to environment sensor signals of the at least one environment sensor.

According to a further preferred embodiment example of the method, the action instructions are output to the person via the activation of the activation patterns in response to environment sensor signals of at least one environment sensor for detecting the position of the person wearing the item of clothing and/or for detecting positions of objects in the environment of the person.

In other words, the computer program product can cause the program commands of the executing computer to receive environment sensor signals of an environment sensor for detecting the position of the person and/or for detecting positions of objects in an environment of the person and generate the input signal from the environment sensor signals or use the environment sensor signal as an input signal.

In a further embodiment of the invention, the at least one environment sensor is arranged on the clothing item.

The arrangement of the environment sensor on the item of clothing makes a compact and practical form of the clothing item possible and no additional fastening or connecting means are required to connect the environment sensor to the item of clothing. However, it is also conceivable that the sensor is not arranged on the item of clothing but remote therefrom; e.g. in order to monitor a region the sensor is arranged on an external object (for example a bicycle).

Moreover, the camera, the environment sensor or the sensor group can be detached from the clothing item itself, e.g. when the belt is worn under clothing, e.g. ski clothing, and the camera, the environment sensor or the sensor group has to be arranged outside of the ski clothing or on the helmet. The sensor then communicates e.g. with the control unit via a means of communication and/or is arranged together therewith; the control unit is formed to automatically switch the communication to wireless communication as soon as the camera, the environment sensor or the sensor group is detached, it is also possible to arrange e.g. the camera, the environment sensor or the sensor group on the rear side of the belt, in order to monitor the region on the rear side of the belt in further/more complex applications.

In a particularly preferred embodiment of the invention, it has proved to be advantageous if the at least one environment sensor includes one of the following elements: satellite navigation device, IR sensor, biocular, camera (e.g. with image recognition, single- or multi-camera systems or stereo camera), lidar, radar, ultrasonic transmitter/receiver combination, accelerometer (acceleration sensor), gyroscope or magnetic sensor. Satellite navigation devices, for example GPS, lidar, radar and, to a certain extent, ultrasound make it possible to detect obstacles. As a result, the person can be guided around the obstacles or can be instructed to stop.

In a further preferred embodiment of the invention, an urgency of an action instruction is coded by the intensity of the activation of at least two actuators.

In a preferred embodiment of the invention, the action instruction includes at least one of the following: move straight on, turn left, turn right, curve to the left, curve to the right, prepare for ascent or descent, prepare for a step up or down, stop, faster, slower, change lanes or check device. Increments are also possible: e.g. tighter curve, less tight curve.

In a further preferred embodiment of the invention, the at least two actuators are arranged on the inner side of the clothing item.

As a result, weak signals or impulses of the actuators can also be better and more quickly perceived.

In a further preferred embodiment of the invention, a protrusion can be formed in the region in which the actuators are arranged.

As a result, the contact with the body and thus the signal transmission can be improved/intensified.

The clothing item can moreover have a so-called “masterbelt” mode. In this mode, the “master” sends motion sequences and routes to nearby “receivers” (other clothing items which are in the “receiver” mode). A time delay corresponding to the distance between the coupled clothing items is integrated. In this way, the “receivers” can follow the route predefined by the “master”.

A playback of previously saved routes is also conceivable; it can be taken into account here that saved routes change over time.

It can be provided that a self-test is performed after switching on, which checks whether all of the actuators are working.

Moreover, it can also be provided that the clothing item is capable of communicating via short-range networks (for example Bluetooth, BLE or Wi-Fi) and long-range networks (for example 3/4/5G).

It can also be provided that the clothing item is supplied with power via a storage battery. However, other portable power sources are also conceivable, e.g. batteries.

Moreover, further features are conceivable, such as e.g. route searches, navigation to sports venues, activity tracking, saving and recalling of routes, navigation to specific positions (e.g. saved home position), position tracking via GPS, emergency call function and training modes.

Further possible areas of application are e.g. as a tactile/haptic means of communication, for emergency services during operations with difficult visibility, for divers (e.g. rescue divers), for the military, in care services for dementia patients or in industry as a means of communication and support.

Thus, not only can the invention be used for the visually impaired, it can also be used as a means of communication in e.g. noisy environments or environments with poor visibility, as well as for work processes which require a high level of attention from the workers and are to intuitively guide the worker through a procedure. Moreover, applications in the games industry or for simulations are also conceivable. Experiences in virtual reality can also be haptically enhanced in this way.

Further advantages and details of the invention are discussed for various embodiment examples on the basis of the figures. There are shown in:

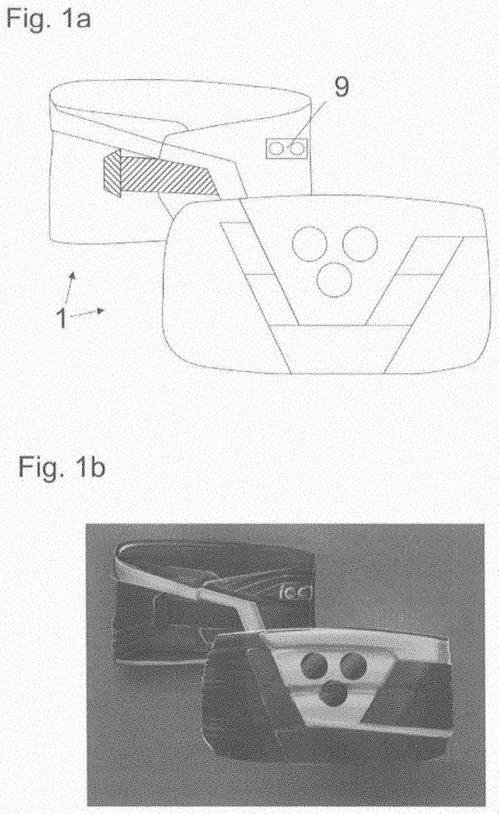

FIGS. 1a, 1b a front and rear view of a possible embodiment variant of the clothing item as a belt,

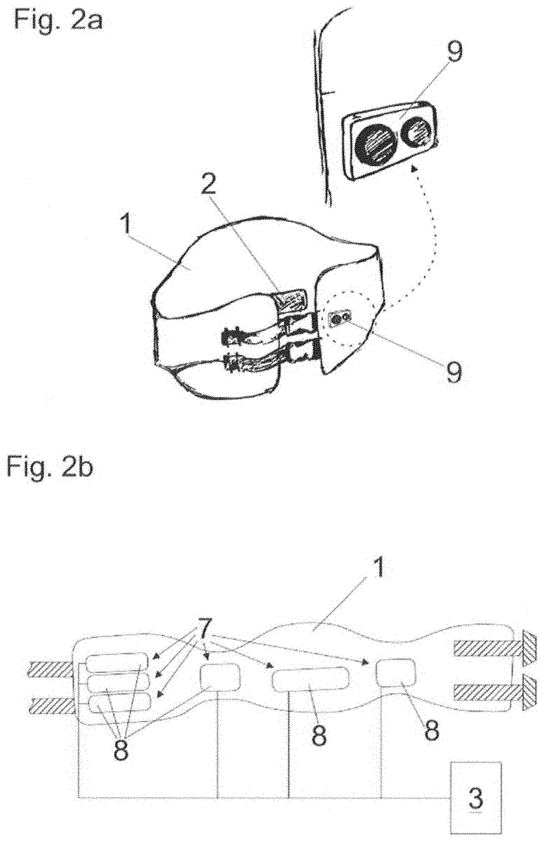

FIGS. 2a, 2b the arrangement of the environment sensor and the actuators on the clothing item,

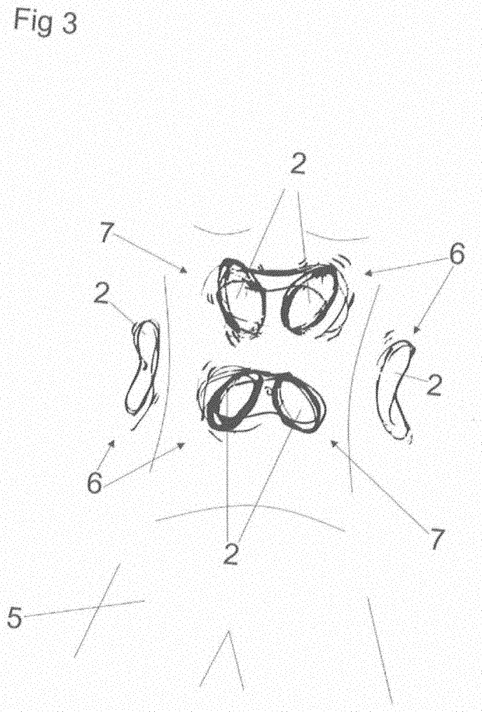

FIG. 3 the arrangement of the actuators on the different parts of the body,

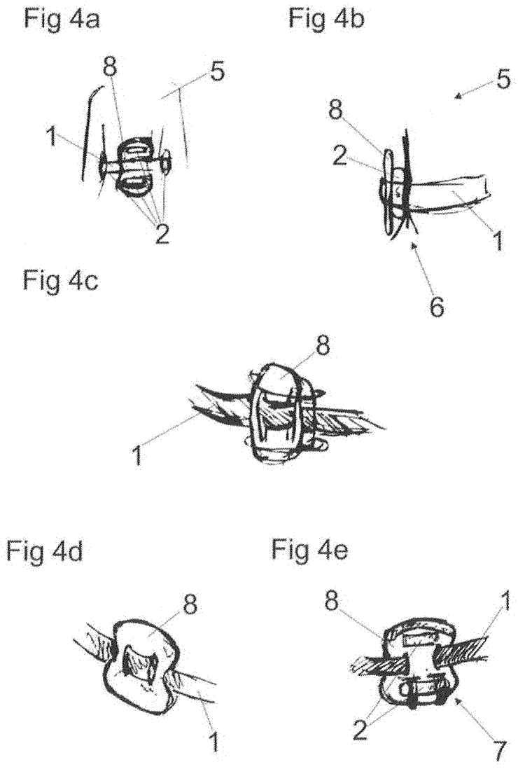

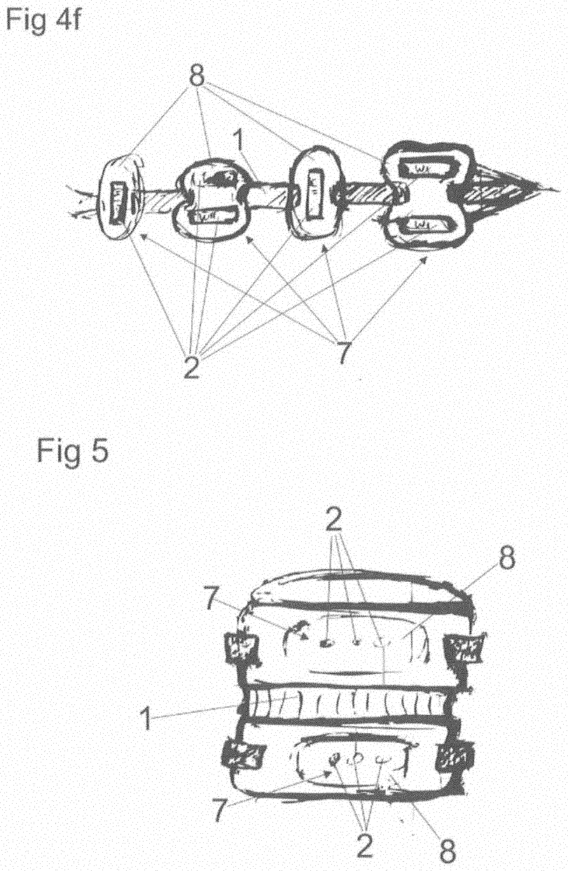

FIGS. 4a-4f different perspectives of a support element arranged on the clothing item,

FIG. 5 a perspective view of an embodiment of the clothing item,

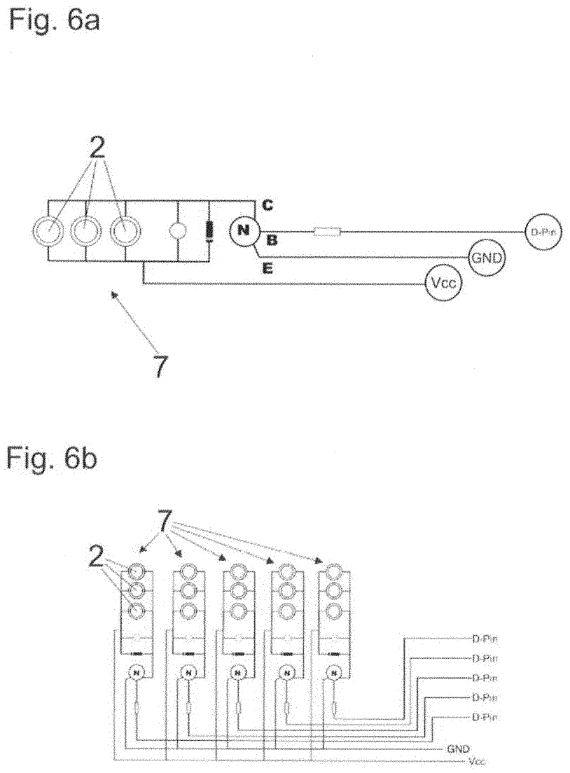

FIGS. 6a, 6b a circuit diagram for the layout of the actuators,

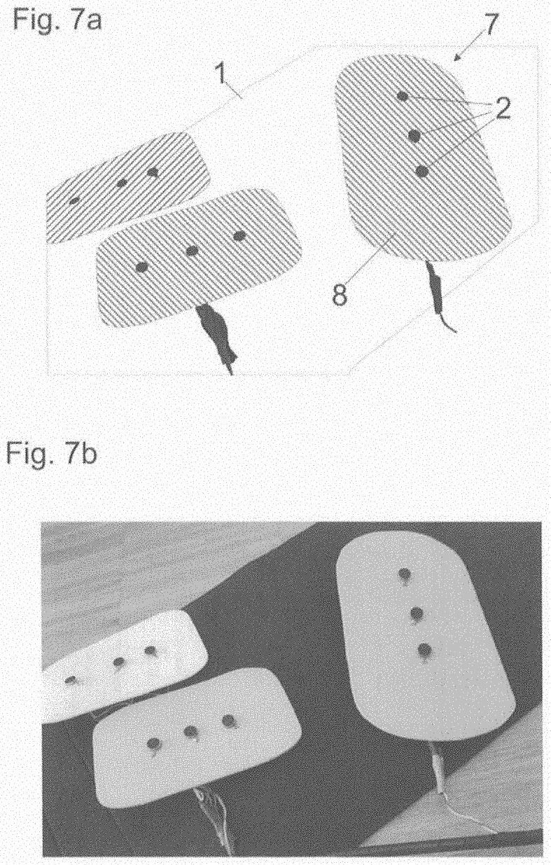

FIGS. 7a, 7b the arrangement of the actuators on a support element in groups,

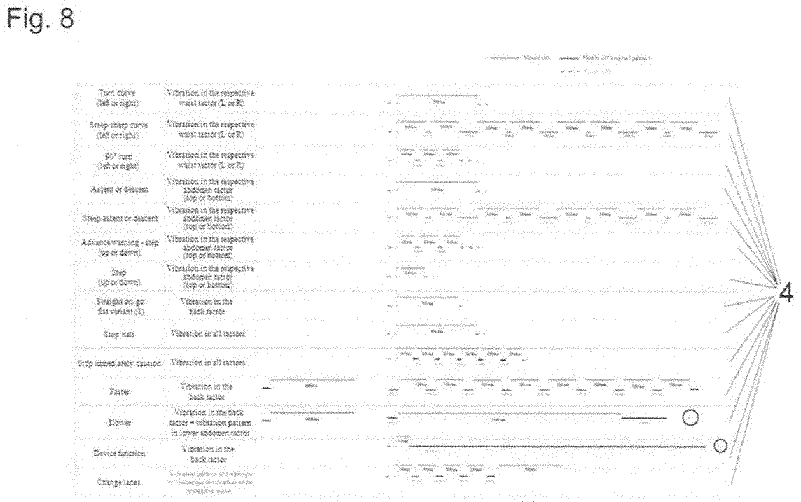

FIG. 8 an example of an activation pattern for cross-country skiing, and

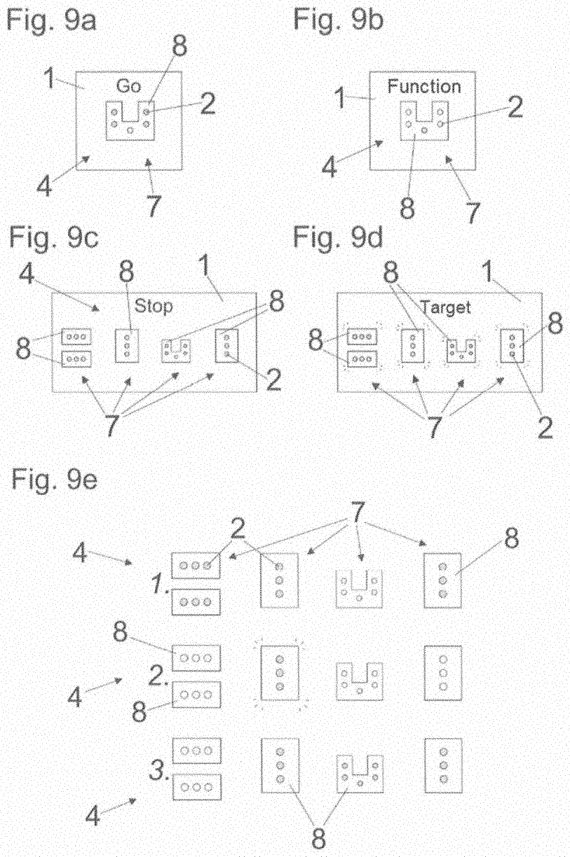

FIGS. 9a-9e different activation patterns.

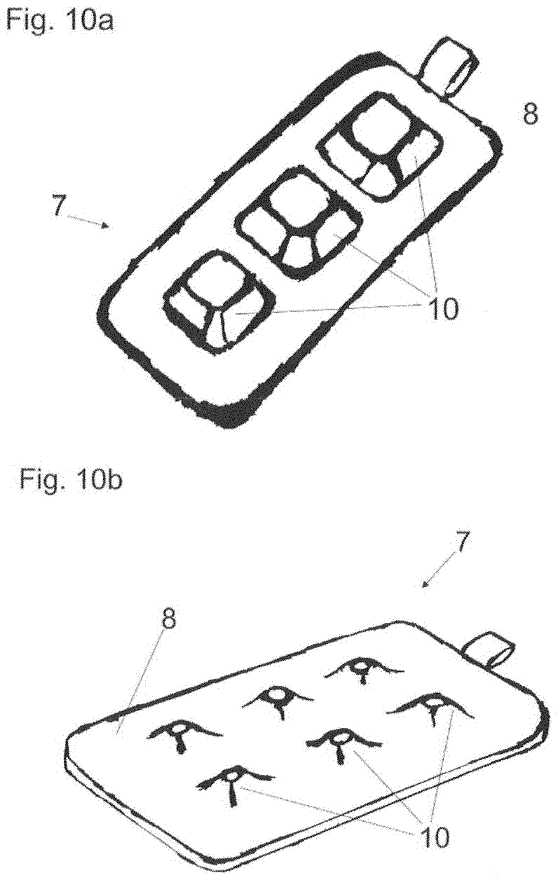

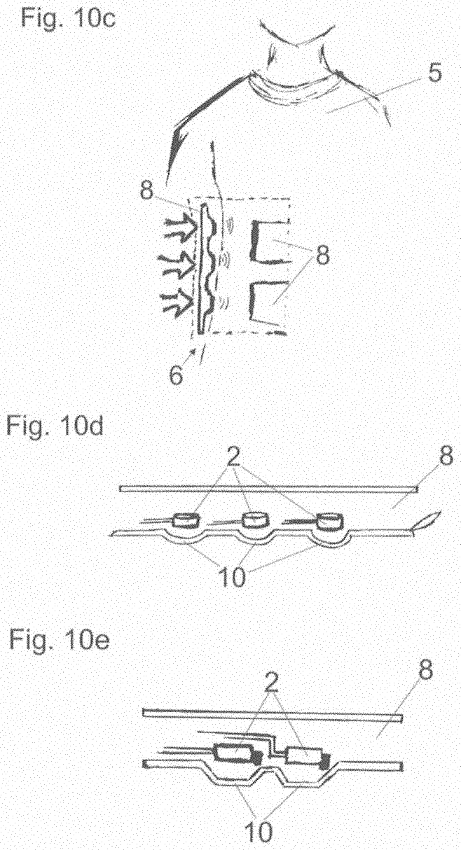

FIGS. 10a-10e different schematic representations of a protrusion in the region of the actuators.

FIG. 1a and, analogously thereto, FIG. 1b show an embodiment example of a clothing item 1 in the form of a belt which is to be worn on the torso of a person 5. An identifying symbol for the visually impaired is pictured on the front side and an environment sensor 9 for detecting the position of the person 5 and/or for detecting positions of objects in an environment of the person 5 is or can be connected on the rear side. The clothing item 1 comprises at least two actuators 2 for triggering tactile stimuli for a person 5 wearing the clothing item 1, wherein
the at least two actuators 2 are or can be connected to a control unit 3 for actuating the actuators 2,
the control unit 3 is formed to activate the at least two actuators 2 within the scope of at least two activation patterns 4, and
the at least two activation patterns 4 are assigned to different action instructions for the person 5 wearing the clothing item 1, which action instructions can be output to the person 5 wearing the item of clothing 1 via the activation of the activation patterns 4,

FIG. 2a shows the arrangement of an environment sensor 9 and an actuator 2 on a clothing item 1.

FIG. 2b shows that the actuators 2 can be activated in groups 7 and that the actuators 2 of a group 7 are arranged on a common support element 8. The control unit 3 is formed to activate the different groups 7 within the scope of at least two activation patterns 4. Moreover, it can be seen that the groups 7 are arranged on the inner side of the clothing item 1. In the embodiment example shown, the support elements 8 are formed in part oval-shaped, although other shapes are also conceivable.

FIG. 3 shows several actuators 2 which are arranged on different parts of the body 6. The actuators 2 are assigned to different muscle groups, wherein the actuators 2 cover, for example, the muscle groups musculus rectus abdominis, musculus obliquus externus abdominis, musculus erector spinae, abdomen, upper abdomen, lower abdomen, back, lower back, upper back, waist, left side of waist and right side of waist.

FIGS. 4a to 4f show that the at least two actuators 2 can be arranged at different locations on the clothing item 1, in particular in order to facilitate and/or improve a precise assignment between the at least two actuators 2 and parts of the body 6 of the person 5 wearing the clothing item 1. It can be seen that the individual support elements 8 can be detached and pressed back on using a hook-and-loop fastener, and can thereby be moved. For this move, however, rails or the like could also be provided. Since the individual support elements 8 can be moved, the position can be adapted to the individual needs of the user.

FIG. 5 shows a perspective representation of the clothing item 1, wherein the clothing item 1 is formed as a corset. It can be seen from this that different forms of clothing from the clothing item 1 according to the invention are also possible.

FIGS. 6a and 6b show that more than two actuators 2 in a group 7 can be activated. It can be seen that a group 7 of actuators 2 is actuated via an electronic circuit. Power can be supplied via a battery, but of course other types of power supply, such as e.g. rechargeable batteries or storage batteries, are also conceivable.

FIG. 7a and, analogously thereto, FIG. 7b show the arrangement of several actuators 2 at different locations on the support element 8 of the respective group 7.

FIG. 8 shows an example or a set of activation patterns 4, with which a wide variety of action instructions can be coded.

It can be advantageous if there are no more than seven basic activation patterns, which are duplicated (left/right, forwards/backwards), since tests show that seven basic activation instructions can be remembered well in the short-term memory.

FIGS. 9a to 9e show some different activation patterns 4 from the table of FIG. 8 which are possible via the differing actuation of the actuators 2. This allows, in particular, the following action instructions to be presented: move straight on, turn left, turn right, curve to the left, curve to the right, prepare for ascent or descent, prepare for a step up or down, stop, faster, slower, change lanes or check device.

FIGS. 10a to 10e show different representations of protrusions 10 which are formed in the region of the actuators 2. Protrusions 10 on a support element 8 can be seen in FIGS. 10a and 10b. In FIG. 10c, it can be seen that the protrusions 10 are formed on the side of the support element 8 facing the part of the body 6. Different embodiments of the protrusion 10 can be seen in FIGS. 10d and 10e.

Although the invention has been described specifically on the basis of the embodiment example shown, it is self-evident that the subject-matter of the application is not limited to this embodiment example. Rather, it is self-evident that measures and modifications which serve to implement the inventive ideas are absolutely conceivable and desired. For example, the clothing item according to the invention could also be designed as a shoe, jacket, waistcoat, trousers, headband or consisting of several straps around arms and/or legs.

The embodiment example shown of a belt or a corset as well as the example described of a possible method for operating such a clothing item are of course not to be understood in a restrictive sense, but rather only as individual examples of numerous possibilities of realizing the inventive ideas of a clothing item with at least two actuators for triggering tactile stimuli.

### LIST OF REFERENCE NUMBERS

1 Clothing item
2 Actuators
3 Control unit
4 Activation pattern
5 Person
6 Part of the body
7 Group
8 Support element
9 Environment sensor
10 Protrusion

1. Clothing item, in particular a belt, with at least two actuators for triggering tactile stimuli for a person wearing the clothing item, wherein
the at least two actuators are or can be connected to a control unit for actuating the actuators,
the control unit is formed to activate the at least two actuators within the scope of at least two activation patterns, and
the at least two activation patterns are assigned to different action instructions for the person wearing the clothing item, which action instructions can be output to the person wearing the clothing item via the activation of the activation patterns,
wherein the at least two activation patterns include the combined activation of the at least two actuators at different parts of the body that are distinguishable for the person wearing the clothing item.

2. The clothing item according to claim 1, wherein the control unit is formed to activate the at least two actuators within the scope of the activation patterns in a predetermined chronological sequence, in particular simultaneously or in a defined chronological series.

3. The clothing item according to claim 1, wherein the at least two activation patterns include the combined activation of a partial quantity of the at least two actuators at different parts of the body that are distinguishable for the person wearing the clothing item.

4. The clothing item according to claim 1, wherein there are more than two actuators, which are preferably activatable in groups, wherein one group preferably contains three actuators.

5. The clothing item according to claim 4, wherein the actuators that are assigned to a group are arranged on a common support element.

6. The clothing item according to claim 1, wherein the at least two actuators are in each case assigned to parts of the body, in particular muscle groups, in particular at least one of the following: abdomen, upper abdomen, lower abdomen, back, lower back, upper back, waist, left side of waist, right side of waist.

7. The clothing item according to claim 1, wherein the at least two actuators can be arranged at different locations on the clothing item, in particular in order to facilitate and/or improve an assignment between the at least two actuators and parts of the body of the person wearing the clothing item.

8. The clothing item according to claim 5, wherein the arrangement of the at least two actuators at different locations is possible via arrangement of the support element of the respective group.

9. The clothing item according to claim 1, wherein the control unit is or can be connected to at least one environment sensor for detecting the position of the person and/or for detecting positions of objects in an environment of the person, and in that the control unit is formed to output the action instructions to the person wearing the item of clothing via the activation of the activation patterns in response to environment sensor signals of the at least one environment sensor.

10. The clothing item according to claim 9, wherein the at least one environment sensor is arranged on the clothing item.

11. The clothing item according to claim 9, wherein the at least one environment sensor includes at least one of the following: satellite navigation device, camera, lidar, radar, ultrasonic transmitter/receiver combination, accelerometer, gyroscope, magnetic sensor.

12. The clothing item according to claim 1, wherein an urgency of an action instruction is coded by an intensity of the activation of the at least two actuators.

13. The clothing item according to claim 1, wherein the action instructions include at least one of the following: turn left, turn right, curve to the left, curve to the right, prepare for ascent or descent, prepare for a step up or down, stop, wherein the action instructions preferably additionally include the following action instructions: move straight on, faster, slower, change lanes, check device.

14. The clothing item according to claim 1, wherein the at least two actuators are arranged on an inner side of the clothing item.

15. The clothing item according to claim 1, wherein protrusions are formed in the region of the actuators.

16. A method for operating at least two actuators on a clothing item, in particular according to claim 1, wherein
within the scope of at least two activation patterns, which are assigned to action instructions for the person wearing the clothing item, the at least two actuators are activated in a combined manner at different parts of the body that are distinguishable for the person wearing the clothing item and
the action instructions are output to the person wearing the item of clothing via the activation of the activation patterns.

17. The method according to claim 16, wherein the action instructions are output to the person via the activation of the activation patterns in response to environment sensor signals of at least one environment sensor for detecting the position of the person wearing the item of clothing and/or for detecting positions of objects in an environment of the person.

18. A computer program product for operating at least two actuators on a clothing item, in particular according to claim 1, having program commands which cause an executing computer to output actuator signals to the at least two actuators within the scope of at least two activation patterns in response to an input signal, with the result that the at least two actuators are activated in a combined manner at different parts of the body that are distinguishable for the person wearing the clothing item.

19. The computer program product according to claim 18, wherein the program commands cause the executing computer to receive environment sensor signals of an environment sensor for detecting the position of the person and/or for detecting positions of objects in an environment of the person and generate the input signal from the environment sensor signals or use the environment sensor signal as an input signal.
